(19) United States
(12) Patent Application Publication
(10) Pub. No.: US 2025/0014079 A1
(43) Pub. Date: Jan. 9, 2025

(54) SYSTEM AND METHOD

(71) Applicant: BOOTROCK INC., Tokyo (JP)

(72) Inventors: Jinya TAKAHASHI, Tokyo (JP); Masahiko ISO, Tokyo (JP); Masakazu OKANO, Tokyo (JP); Hisayoshi SASAKI, Tokyo (JP); Yu TORITSUKA, Tokyo (JP); Hitoshi YAKUWA, Tokyo (JP); Yasufumi HATTORI, Tokyo (JP)

(73) Assignee: BOOTROCK INC., Tokyo (JP)

(21) Appl. No.: 18/711,365

(22) PCT Filed: Nov. 21, 2022
(86) PCT No.: PCT/JP2022/043082

§ 371 Date: May 17, 2024

(30) Foreign Application Priority Data
Nov. 22, 2021 (JP) 2021-189691

(51) Int. Cl. G06Q 30/0601

(52) U.S. Cl. CPC G06Q 30/0601; G06Q 30/0641

(57) ABSTRACT

An object of the present invention is to provide a system which can transmit part or all of the product information corresponding to a product purchased by a user, to another user terminal.

[Solution to Problem]

A system including at least one computer apparatus, the system comprising: a sending information generator that generates, by operation on a user terminal, sending information for transmitting part or all of product information corresponding to a product purchased by a user to another user terminal operated by another user; and a transmitter that transmits part or all of the product information to the other user terminal when the sending information is selected or input on the other user terminal.

### TECHNICAL FIELD

The present invention relates to a system and a method.

### BACKGROUND ART

Recently, products with added values such as contents such as CDs with admission tickets or benefit tickets of events such as concerts are sold. Depending on the number of acquired benefit tickets, the options which can be selected by the purchaser vary; for example, the options allow not only participation in concerts at events, but also allow handshake with artists or photographing. The buying interest of the consumers who are to purchase more CDs can be enhanced by the added value of the benefit tickets, etc., and one consumer sometimes purchases a plurality of CDs.

Herein, for example, Patent Literature 1 is disclosed as a system which can mark up the price of a medium and distribute a paid extra content (video, image, sound source, prize, or product) when the medium is purchased at a retail store or the medium is rented at a rental store. However, it does not enable a user to purchase the medium and the extra content at the same time on the Internet. Also, there is no consideration about modes for purchasing the medium a plurality of times and secondary distribution of the medium.

Also, for example, Patent Literature 2 is disclosed as a usage-right transferring system which enables transfer of the right about usage of a content without impairing the right of a content holder and a content user. However, in transfer of the usage right, the counterpart of the transfer has to be designated. Also, there is no consideration about a mode which prompts a transferor and a transferee for transfer of the right.

### CITATION LIST

### Patent Literature

Patent Literature 1: JP 2003-348076 A

Patent Literature 2: JP 2003-242032 A

### SUMMARY OF INVENTION

### Technical Problem

The present invention can solve, for example, any of following problems. A first problem of the present invention is to provide, regarding product information corresponding to a product purchased by a user, a system which can transmit part or all of the product information to another user terminal. A second problem of the present invention is to provide a system which can prompt provision of part or all of the product information from the user to the other user and/or to provide a system which can provide a benefit to the other user to whom part or all of the product information is provided from the user. A third problem of the present invention is to provide a system which can manage the product including content information and product benefit information.

### Solution to Problem

The above objects are achieved by providing the following:
[1] A system including at least one computer apparatus, the system comprising: a sending information generator that generates, by operation on a user terminal, sending information for transmitting part or all of product information corresponding to a product purchased by a user to another user terminal operated by another user; and a transmitter that transmits part or all of the product information to the other user terminal when the sending information is selected or input on the other user terminal;
[2] The system according to the [1], wherein the transmitter transmits part or all of the product information to the other user terminal only by a predetermined number of transmission, and the predetermined number of transmission is a number provided depending on predetermined information about product purchase;
[3] The system according to the [1] or [2], wherein part or all of the product information transmitted to the other user terminal can be used by the other user terminal with a limit of a predetermined period or a predetermined number;
[4] The system according to any one of the [1] to [3], comprising a first benefit provider that makes registration to provide a first benefit to the user when a predetermined first condition is satisfied and/or determines the first benefit provided to the user when the predetermined first condition is satisfied;
[5] The system according to any one of the [1] to [4], comprising a second benefit provider that makes registration to provide a second benefit to the other user when a predetermined second condition is satisfied and/or determines the second benefit provided to the other user when the predetermined second condition is satisfied;
[6] The system according to the [4] or [5], wherein the predetermined first condition and/or the predetermined second condition is: a fact that part or all of the product information has been transmitted to the other user terminal, a fact that part or all of the received product information has been used by the other user terminal, a fact that information about a benefit to be provided to the user has been input by operation input on the other user terminal, and/or a fact that a number of transmission of part or all of the product information to the other user terminal is equal to or less than a predetermined number;
[7] The system according to any one of the [4] to [6], wherein the first benefit and/or the second benefit allows the user and/or the other user to make a purchase before predetermined sales date regarding a purchase of a predetermined product, to purchase the predetermined product, to purchase the predetermined product by increasing an upper limit on a purchasable number of the predetermined product, and/or to execute, regarding a predetermined lottery, the lottery at a lottery probability increased by a predetermined rate;
[8] The system according to any one of the [4] to [7], comprising a number storage that stores, in association with single sending information, a number of an allowed transmission of part or all of the product information to the other user terminal, wherein the first benefit and/or the second benefit increases an upper limit of the number of the allowed transmission;
[9] A method executed in a system including at least one computer apparatus, the method comprising: a sending information generating step of generating, by operation on a user terminal, sending information for transmitting part or all of product information corresponding to a product purchased by a user to another user terminal operated by another user; and a transmitting step of transmitting part or all of the product information to the other user terminal when the sending information is selected or input on the other user terminal;
[10] A system including at least one computer apparatus, the system comprising: a transmitter that transmits part or all of product information corresponding to a product purchased by a user to another user terminal operated by another user; and a first benefit provider that makes registration that a first benefit is to be provided to the user when a predetermined first condition about transmission of the product information to the other user terminal is satisfied and/or determines the first benefit to be provided to the user when the predetermined first condition is satisfied;
[11] A system including at least one computer apparatus, the system comprising: a transmitter that transmits part or all of product information corresponding to a product purchased by a user to another user terminal operated by another user; and a second benefit provider that makes registration that a second benefit is to be provided to the other user when a predetermined second condition about transmission of the product information to the other user terminal is satisfied and/or determines the second benefit to be provided to the other user when the predetermined second condition is satisfied;
[12] A method executed in a system including at least one computer apparatus, the method comprising: a transmitting step of transmitting part or all of product information corresponding to a product purchased by a user to another user terminal operated by another user; and a first benefit providing step of making registration that a first benefit is to be provided to the user when a predetermined first condition about transmission of the product information to the other user terminal is satisfied and/or determining the first benefit to be provided to the user when the predetermined first condition is satisfied;
[13] A method executed in a system including at least one computer apparatus, the method comprising: a transmitting step of transmitting part or all of product information corresponding to a product purchased by a user to another user terminal operated by another user; and a second benefit providing step of making registration that a second benefit is to be provided to the other user when a predetermined second condition about transmission of the product information to the other user terminal is satisfied and/or determining the second benefit to be provided to the other user when the predetermined second condition is satisfied;
[14] A system including at least one computer apparatus, the system comprising: a storage that stores product information including content information and product benefit information as a single product and a product information transmitter that transmits the product information including the content information and the product benefit information corresponding to the product purchased by a user to a user terminal operated by the user; wherein, the product benefit information is information about admission to an event related to the content information and/or information about a benefit related to the content information;
[15] The system according to the [14], wherein the product benefit information is information about a benefit related to the content information, the system comprising a benefit provider that provides the benefit of a predetermined volume depending on predetermined information about product purchase, and an option that can be executed by the user varies depending on the volume of the provided benefit;
[16] The system according to the or [15], wherein the product benefit information is the information about admission to the event, and the system comprising an admission ticket provider that provides one admission ticket of the event, regardless of the number of product purchase, when the user purchases the product;
[17] The system according to any one of the to [16], wherein the product benefit information is the information about admission to the event, and a rank of a seat in the event varies depending on the predetermined information about product purchase or predetermined information about admission to the event;
[18] The system according to any one of the to [17], comprising a lottery executer that carries out, depending on the predetermined information about the product purchase, the predetermined information about admission to the event, or predetermined information about the benefit related to the content information, a lottery about the rank of the seat in the event or the benefit related to the content information;
[19] The system according to any one of the to [18], comprising an admission information input receiver that receives, by operation on an administrator terminal operated by an administrator, input of a number of the user terminal serving as a destination of the transmission of the information about admission to the event, and the product information transmitter transmits the product information including the information about admission to the event until the number of the user terminal, which has been transmitted the information about admission to the event, reaches the input number of the user terminal;
[20] The system according to any one of the [1] to [19], comprising a list display controller that carries out control so as to display, by a list, a name of the purchased product, the number of the product purchased, a volume of the benefit ticket unused, and/or the number of an allowed transmission of the part or all of the product information to the other user terminal;
[21] A method executed in a system including at least one computer apparatus, the method comprising: a storage step of storing product information including content information and product benefit information as a single product and a product information transmitting step of transmitting the product information including the content information and the product benefit information corresponding to the product purchased by a user to a user terminal operated by the user; wherein, the product benefit information is information about admission to an event related to the content information and/or information about a benefit related to the content information.

### Advantageous Effects of Invention

According to the present invention, a system which can transmit part or all of the product information corresponding to a product purchased to another user terminal can be provided. According to the present invention, a system which can prompt provision of part or all of the product information from the user to the other user and/or to provide a system which can provide a benefit to the other user to whom part or all of the product information is provided from the user can be provided. Moreover, according to the present invention, a system which can manage the product including content information and product benefit information can be provided.

### BRIEF DESCRIPTION OF DRAWINGS

FIG. 1 is a block diagram illustrating a configuration of a system according to an embodiment of the present invention.

FIG. 2 is a block diagram illustrating a configuration of the user terminal according to an embodiment of the present invention.

FIG. 3 is a block diagram illustrating a configuration of the server apparatus according to an embodiment of the present invention.

FIG. 4 is a diagram illustrating a flow chart of the purchasing process according to an embodiment of the present invention.

FIG. 5 is a diagram illustrating an example of the display screen of the purchased product according to an embodiment of the present invention.

FIG. 6 is a diagram illustrating an example of the display screen of the purchased product list according to an embodiment of the present invention.

FIG. 7 is a diagram illustrating an example of the display screen of an owned benefit ticket list according to an embodiment of the present invention.

FIG. 8 is a diagram illustrating an example of the display screen of an owned admission ticket list according to an embodiment of the present invention.

FIG. 9 is a diagram illustrating a flow chart of the sending information generating process according to an embodiment of the present invention.

FIG. 10 is a diagram illustrating a flow chart of the gift sending and gift-benefit providing process according to an embodiment of the present invention.

### DESCRIPTION OF EMBODIMENTS

Hereinafter, embodiments of the invention will be described. The invention, however, is not limited to the following embodiments without departing from the spirit of the invention. Hereinafter, description relating to effects shows an aspect of the effects of the embodiments of the invention and does not limit the effects. The order of the processes constituting the flow charts described below is a random order within the range that does not cause inconsistencies and discrepancies in the process substances. Moreover, within the range that does not cause inconsistencies and discrepancies in the process substances, part of the processes constituting the flow charts can be omitted, and/or a new process(es) can be added to the processes constituting the flow charts.

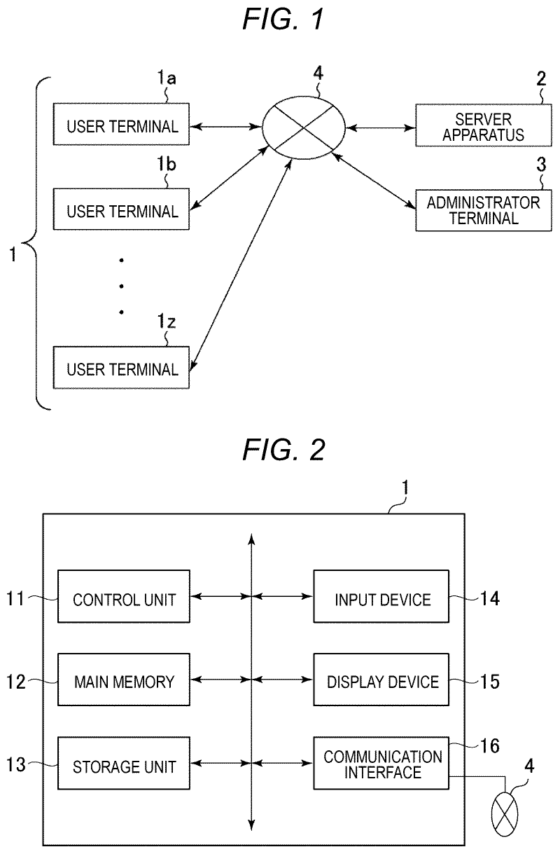

FIG. 1 is a block diagram illustrating a configuration of a system according to an embodiment of the present invention. As illustrated, the system includes a user terminal 1, a server apparatus 2, an administrator terminal 3, and a communication network 4. The user terminal 1 operated by a user can be connected to communicate with the server apparatus 2 via the communication network 4. Also, the system may be provided with a plurality of user terminals 1a to 1z as the user terminal 1. Hereinafter, the terminal operated by the user will be referred to as the user terminal, and the terminal(s) operated by another (other) users will be referred to as another (other) user terminals. For example, the user terminal 1 may refer to the user terminal 1a, and the other user terminal 1 may refer to the user terminal 1b. Note that the system according to the embodiment of the present invention is only required to have at least one computer apparatus.

Also, the administrator terminal 3 is operated by an administrator who administers contents (for example, a record company representative, a content holder, or the like). The administrator terminal 3 can be connected to communicate with the server apparatus 2 via the communication network 4. Also, the system may be provided with a plurality of administrator terminals 3 as the administrator terminal 3.

The user terminal 1 and the administrator terminal 3 are not particularly limited as long as the terminal is a computer apparatus including a display screen and an input unit. The user terminal 1 and the administrator terminal 3 may be a stationary type and installed in a company office or the like, or the terminal may be a portable type which can be carried when a user moves. Examples of the user terminal 1 and the administrator terminal 3 include conventional portable phones, tablet-type terminals, smartphones, wearable devices, desktop-type/laptop-type personal computers. Note that, in the system of the present invention, it is preferred to use, as the user terminal 1, a mobile terminal in which a dedicated application program is installed.

FIG. 2 is a block diagram illustrating a configuration of the user terminal according to an embodiment of the present invention. The user terminal 1 is provided with a control unit 11, a main memory 12, a storage 13, an input device 14, a display device 15, and a communication interface 16, which are mutually connected by buses. The user terminal 1 may also be provided with a sound output device.

The control unit 11 includes a CPU and a ROM. The control unit 11 executes programs stored in the storage 13 and controls the user terminal 1. As the main memory 12, for example, a RAM is used. The main memory 12 is a work area of the control unit 11. The storage 13 is a storage area for saving programs and data. The control unit 11 carries out arithmetic processing based on the programs and data read from the main memory 12 and the data input by the input device 14.

The display device 15 has a display screen. In accordance with the results of the arithmetic processing, the control unit 11 outputs video signals for displaying images on the display screen. Herein, the display screen may be a touch panel provided with a touch sensor. In such a case, the touch panel functions as the input device 14. Also, the user terminal 1 may be provided with a camera so that the camera functions as the input device 14.

The communication interface 16 can be connected to the communication network 4 by radio or by wire and can transmit/receive data to/from the server apparatus 2 or the administrator terminal 3 via the communication network 4. The data received via the communication interface 16 is loaded into the main memory 12 and is subjected to arithmetic processing by the control unit 11.

The administrator terminal 3 has a configuration similar to the user terminal 1 and, for example, is provided with a control unit, a main memory, a storage, an input device, a display device, and a communication interface, which are mutually connected by internal buses.

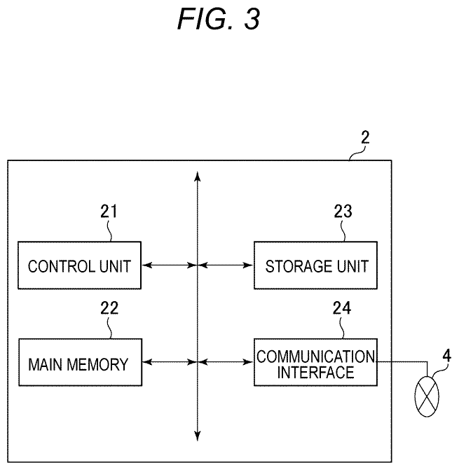

FIG. 3 is a block diagram illustrating a configuration of the server apparatus according to an embodiment of the present invention. The server apparatus 2 is provided with a control unit 21, a main memory 22, a storage 23, and a communication interface 24, which are mutually connected by buses.

The control unit 21 includes a CPU and a ROM, executes programs stored in the storage 23, and controls the server apparatus 2. Also, the control unit 21 is provided with an internal timer, which measures time. The main memory 22 is a work area of the control unit 21. The storage 23 is a storage area for saving programs and data. The control unit 21 reads programs and data from the main memory 22 and carries out arithmetic processing based on, for example, the information received from the user terminal 1 or the administrator terminal 3.

The system according to the embodiment of the present invention stores, as one product, product information including content information and product benefit information and transmits the product information including the content information and the product benefit information, which corresponds to the product purchased by the user, to the user terminal 1 operated by the user, thereby providing the product, which includes the content information and the product benefit information, to the user. In other words, the system enables the user to purchase the product including the content information and the product benefit information.

Also, in the system, depending on predetermined information (also referred to as predetermined conditions) about a product purchase(s), a benefit(s) of a predetermined volume can be provided to the user terminal 1. Examples of the predetermined information about the product purchase(s) include the number of product purchases, a product purchase money amount, the type of the purchased product(s), a cumulative purchase money amount, a combination of purchased products, etc.

Herein, in the embodiment of the present invention, “product” refers to a thing which independently serves as a target of a commercial transaction and may be a tangible object or an intangible object. The “product information” is the information about a product which can be purchased by the user and is preferred to be the information including content information and product benefit information as one product. Also, the product information at least includes content information, is not required to include product benefit information, and may include content information or product benefit information. The product information is set when the administrator operates the administrator terminal 3 and is stored in the server apparatus 2. Also, it is preferred that the product information is stored in the server apparatus 2 in association with product identification information, which enables identification of the product on sale.

Also, the product information may have a serial code in addition to the product identification information. The serial code is expressed by a random alphanumeric characters, and a unique serial code is issued for each product. The serial code is stored in association with single product information and can be also described as identification information, which enables identification of the product information. The user may be enabled to acquire content information and/or product benefit information by transmitting the serial code to the server apparatus 2 by operation on the user terminal 1 and specifying the product information in the server apparatus 2.

Also, in the embodiment of the present invention, “contents” refers to the information which can be objects of commercial transactions and can be generally applied to digital contents such as music, images, videos, movies, dramas, texts, e-books, games. Note that the following embodiment will mainly describe the case in which contents related to music are used.

The “content information” refers to the information about a content(s), and, for example in the case of content information about music contents, the “content information” may include a plurality of pieces of information such as the information of a lyrics card, a jacket photograph image, and a video of a music video in addition to the information of a sound source of a musical composition. In other words, in the case of music contents, the content information can be the information about various contents generally included in a CD.

In the embodiment of the present invention, “benefit information” is the information about a benefit(s) which is advantageous to the user. Note that “benefit information” includes product benefit information (also referred to as a product benefit), which is stored together with content information in association with the product information and is provided to the user who has purchased the product, and gift benefit information (also referred to as a gift benefit), which is provided to the user and/or another user when a predetermined condition(s) is satisfied when the user transmits part or all of the owned product information to another user terminal. Note that, among the gift benefits, the gift benefit provided to the user who has transmitted the product information is referred to as a first benefit, and the gift benefit provided to the other user who has received the product information is referred to as a second benefit.

The “product benefit information”, which is the benefit information included in the product information, is not particularly limited as long as the product benefit information is the information about a benefit(s), which is advantageous to the user who has purchased the product. The product benefit information is, for example, the information about admission to an event related to the content information, the information about a benefit related to the content information, and/or the information related to a digital benefit(s). The product benefit information is not limited to the information which can be transmitted to the user terminal, but also may be tangible objects such as prizes, coupon tickets, and currencies, which are not information. Also, it may be an object related to the content(s) included in the product information or may be an irrelevant object.

Examples of the information of the product benefit about admission to an event related to the content information include an admission ticket, which is the information about admission to the event. The “admission ticket” is one type of the product benefit information and has the information about admission and participation of the event related to the content information. The admission ticket, for example, may ensure the right of admission to the event or may enable entry to a lottery of the admission to the event. Also, the admission ticket may be an object which shows an admission serial number or a seat number of the event. Also, the events include both events held at actual event venues and the events held online. The admission tickets are also referred to as tickets. Details of the admission tickets will be described later.

Examples of the information of the product benefit about the benefit related to the content information include the information about a benefit which can be used at the event. Also, the information of the product benefit about the benefit related to the content information may include the information which enables lottery or entry the benefit stored in association with the product information. The benefits related to the content information are not particularly limited as long as the benefits are benefit tickets, contents, prizes, options executable by the users in the events related to the content information, and/or the things which enhance added values of other products. Also, the option executable by the user may vary depending on the volume of the benefits provided to the user terminal 1.

In the embodiment of the present invention, the “benefit ticket” is one type of the product benefit information and includes the information about a benefit related to the content information. The user can select different options at the event related to the content information depending on the number of acquired benefit tickets. Regarding the different options, ranks may be set for the options, respectively. In other words, depending on the predetermined information about the benefit ticket, the type and rank of the option executable at the event vary. Examples of the options which can be selected include acquisition of prizes, a handshake with an artist, photographing with the artist, predetermined time of conversations, etc.

The information related to a digital benefit (also referred to as a digital benefit) of the product benefit is a content(s) related to the product information and/or the content information and is the information which is different from the content information. The digital benefits are not particularly limited as long as the digital benefits are digital contents. Examples of the digital benefits may include photograph images, sound, videos, message texts, etc. of artists. Also, the digital benefits may have limits on the number or timing of reproduction.

Also, the system can generate, by operation on the user terminal 1a, sending information for transmitting part or all of the product information corresponding to the product purchased by the user to the other user terminal 1b operated by the other user and, when the sending information is selected or input on the other user terminal 1b, can transmit part or all of the product information to the other user terminal 1b.

Herein, in the embodiment of the present invention, the function which enables transmission of part or all of the product information owned by the user to the other user terminal for the other user is referred to as “gift sending function”. A gift is part or all of the product information which can be transmitted to the other user terminal, and examples of part of the product information include content information, product benefit information, admission tickets, benefit tickets, digital benefits, etc. In other words, part of the product information may only be the content information included in the product information, may only be the product benefit information, or a combination of one or more pieces of information such as an admission ticket and a benefit ticket. Also, if the content information includes a plurality of pieces of information, among the information included in the content information, any one or more pieces of information can be transmitted to the other user terminal 1b. In the system, which information can be transmitted to the other user terminal 1b as a gift(s) is preferred to be set in advance by operation on the administrator terminal 3 by the administrator.

The system may, when a predetermined first condition is satisfied, make registration that a first benefit is to be provided to a user and/or may, when the predetermined first condition is satisfied, determine the first benefit to be provided to the user; or the system may, when a predetermined second condition is satisfied, make registration that a second benefit is to be provided to another user and/or, when the predetermined second condition is satisfied, determine the second benefit to be provided to the other user.

Note that, in the embodiment of the present invention, a serial code may be provided to the user as a product benefit, a gift benefit, a benefit ticket, and/or an admission ticket. Since a single serial code is stored in association with single product information, when the serial code and the identification information of the user is transmitted to another computer apparatus such as the server apparatus 2, the serial code enables acquisition of the right to participate in an event related to the content information, acquisition of a benefit related to the content information, or entry to a lottery thereof.

Also, a limited content or prize may be acquired by using the serial code, and usage of the serial code is not particularly limited. Note that entry about an event or a product benefit using the serial code can be executed on a dedicated site of an artist related to the content information or on a dedicated app. Together with the serial code, URL of a site on which entry about the event or the benefit can be made may be transmitted to the user terminal 1.

Note that specific details of the product information, the content information, the product benefit information, and/or the gift benefit information can be arbitrarily set by operation on the administrator terminal 3 by an artist, an administrator, an organizer of the event, or the like.

Since the system can detect the type of the user, the date of purchase, the number of content reproduction, the number of transmissions of the content to the other user(s), etc. about the product purchased by the user, statistical information about sales can be suitably managed.

### [Initial Setting Processing]

First, a product information transmitting process of the system will be described. In the embodiment of the present invention, an application program (hereinafter, referred to as a dedicated app) downloaded to the user terminal 1 can be used, and it is preferred to cause the user to set initial settings when the dedicated app is activated for the first time on the user terminal 1.

As the initial settings, for example, a name, a nickname, a user ID for identifying the user, a mail address, a password, the date of birth, a prefecture, etc. are input. The information of the input initial settings is transmitted to the server apparatus 2 together with identification information (also referred to as an identification number unique to the terminal. For example, UDID is shown) of the user terminal 1 used by the user and is stored in the server apparatus 2 in association with the information input as the identification information of the user terminal 1. Therefore, when the dedicated app is activated by the user terminal 1, the identification information of the user terminal 1 is transmitted to the server apparatus 2 by the user terminal 1. Since the user is specified in the server apparatus 2 by the identification information of the user terminal 1, the user can omit operation of login to the dedicated app. Note that, hereinafter, the user ID with which the user can be identified or the identification information of the user terminal 1 may be described as user identification information.

Note that a configuration in which the system can be used by two different user terminals 1 by using the same single account (user ID) can be also employed. In such a case, the identification information of the user terminals 1 and the user ID are associated with each other and stored in the server apparatus 2. Therefore, in the case in which the information of two or more terminals is stored in association with a single user ID, it is preferred to, for example, show a display for user confirmation whether the plurality of terminals may be registered for the same user ID. Also, the information of the initial settings and the identification information of the user terminals 1 is preferred to be encrypted when the information is stored in the server apparatus 2.

### [Product Purchasing Process]

Next, a product purchasing process in the system will be described. First, the user operates the user terminal 1 and selects a product to be purchased on an EC site of an arbitrary store shown by a web browser. In this process, a user ID is input by operating the user terminal 1. A request to purchase the product is transmitted from the user terminal 1 to a web server of the EC site. The product purchase request includes the user ID, the product identification information of the product to be purchased, and the volume of the product to be purchased.

When the product purchase request is received by the web server, the product purchase request is transmitted from the web server to the server apparatus 2. In the server apparatus 2, when it is judged that the user ID included in the product purchase request is stored, a process about purchasing the product is executed. When the process about purchasing the product is executed, in the server apparatus 2, the product information specified from the product identification information and the user ID (user identification information) is associated with each other and stored. As a result, even when the product is purchased via an arbitrary EC site, the user identification information of the user who has purchased the product and the product information is associated with each other and stored in the server apparatus 2. The user can use the product, which has been purchased via the arbitrary EC site, on the dedicated app.

Note that, after the dedicated app is activated, the display screen of the user terminal 1 may show icons linked to the EC sites of a plurality of stores where the product can be purchased. When the user presses the icon of the store displayed on the user terminal 1, a transition to the EC site of the store can be made.

### [Product Information Transmitting Process]

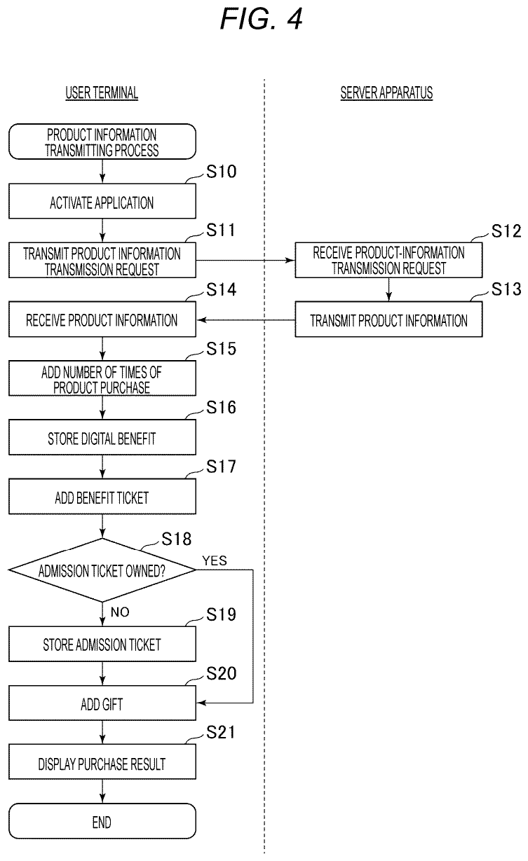

Next, the product information transmitting process of the system will be described. The product information transmitting process is a process for using the product, which has been purchased by the user, on the dedicated app. FIG. 4 is a diagram illustrating a flow chart of the product information transmitting process according to an embodiment of the present invention. When the user carries out operation, the dedicated app is activated in the user terminal 1 (step S10).

When the dedicated app is activated, a product information transmission request is transmitted from the user terminal 1 to the server apparatus 2 (step S11). In this process, together with the product information transmission request, the user identification information is transmitted to the server apparatus 2. When the product information transmission request is received by the server apparatus 2 (step S12), the product information stored in association with the user identification information is specified. The product information is transmitted from the server apparatus 2 to the user terminal 1 (step S13), and the product information is received by the user terminal 1 (step S14).

Note that, as described above, the user identification information and the product information purchased by the user is associated with each other and stored in the server apparatus 2. Therefore, the product information transmitted in step S13 corresponds to the product purchased by the user in advance.

When the product information is transmitted to the user terminal 1 in step S13, the product information is received by the user terminal 1 (step S14). In this process, the product information stored in the user terminal 1 is referenced to detect whether the product information has been received one or more time(s) or not by the user terminal 1. If it is the first time to receive the product information, the product information is newly stored in the user terminal 1. When the product information is stored in the user terminal 1, a screen about the product corresponding to the product information is generated in the user terminal 1. The generated screen can be displayed by the display screen of the user terminal 1. The user can use the content information and the product benefit information, which is included in the product information, on the screen about the product corresponding to the product information displayed by the display screen of the user terminal 1. Note that, if it is the second or subsequent time to receive the product information, the screen about the product corresponding to the product information has already been generated.

Next, in the user terminal 1, the number of product purchases of the product purchased by the user is added (step S15). Next, the digital benefit is stored in the user terminal 1 (step S16). Next, the number of the benefit ticket(s) is added to the number of the benefit ticket(s) owned in the user terminal 1 (step S17). Next, whether the admission ticket is already owned or not is judged in the user terminal 1 (step S18). If the admission ticket is not owned (NO in step S18), the admission ticket is stored (step S19). If the admission ticket is owned (YES in step S18), step S19 is not executed, but following step S20 is executed.

Next, the number of allowed transmissions of the gift is added in the user terminal 1 (step S20). Then, the purchase result of the product is displayed by the user terminal 1 (step S21). The product information transmitting process is terminated by the processes of above steps S10 to S21. The information calculated and the information stored in steps S15 to S20 is stored in association with the user identification information in the server apparatus 2.

Note that the processes of steps S15 to S18 and S20 may be executed in a switched order. In a case in which the order of step S18 is switched, if YES in step S18, step S19 is not executed. Also, if the product information does not include the benefit ticket, the admission ticket, and/or the digital benefit, the processes of steps S15 to S19 corresponding thereto are not executed.

Also, the processes of steps S15 to S20 may be executed by the server apparatus 2. Alternatively, after the product purchase request transmitted from the user terminal 1 is received by the server apparatus 2, steps S15 to S20 may be executed by the server apparatus 2, and the calculated information and the stored information may be stored in the server apparatus 2 in association with the user identification information. In this case, when the product information and the stored information is transmitted in step S13, the process of step S21 is executed.

Note that, in the embodiment of the present invention, when the user purchases the product, one admission ticket of the event is provided regardless of the number of product purchases. Therefore, it is preferred that only one admission ticket of the single event is associated and stored with respect to the single user ID. In other words, in the system, regardless of the number of product purchases, regarding admission tickets, the number of the admission ticket(s) owned by the user can be fixed.

Also, in a case in which there is a plurality of events related to admission tickets to which entries can be made, whether the admission ticket of each event is owned or not may be judged in step S18; alternatively, if the admission ticket is owned for at least one event, the user may be judged to own the admission ticket so that any new admission ticket is not provided to the user. Also, if there is a different event of the same artist or the admission ticket is owned for at least one event in a predetermined period, the user may be judged to own the admission ticket so that any new admission ticket is not provided to the user. In other words, with respect to the events having the same product attribute or the events in a predetermined period, the number of the admission ticket(s) owned by the user can be fixed.

Note that the judgement of the presence/absence of the admission ticket is carried out by the presence/absence of the event(s) stored in association with the single user ID in the user terminal 1 and/or the server apparatus 2. Therefore, the presence/absence of the admission ticket can be judged not only for the same product, but also in the case in which the same event is to be held for a plurality of different products.

Also, when a product having the information about admission to an event is to be purchased, the user can operate the user terminal 1 in a purchasing process of the product to select the event he/she wants to participate. Alternatively, after the product information transmitting process, the user may operate the user terminal 1 to select the admission ticket and select the event to participate. If there is a plurality of related events, any of the events he/she wants to participate can be selected. In this case, even if a plurality of admission tickets which allows participation in a plurality of events is owned, only one admission ticket can be acquired for the single event. Also, the following lottery process may be carried out.

Herein, in the system, depending on predetermined information about product purchase, predetermined information about admission to the event, or predetermined information about the benefit related to the content information, a lottery about admissibility of the event, the seat in the event, the rank of the seat, or the type of the seat may be carried out. Examples of the predetermined information about admission to the event include the number of the admission ticket(s) owned by the user, the rank of the admission ticket(s), etc. Also, examples of the predetermined information about the content information include the number of the benefit ticket(s) owned by the user, the type(s) of the benefit ticket(s), a combination of the benefit tickets, etc. Note that the number of lotteries allowed can be set based on the above described predetermined information. Also, an upper limit for the number of lotteries allowed may be set for each user, and a purchase limit per one transaction may be provided for the purchased product.

In the product information transmitting process, if the product involves a lottery of the admission ticket, the following process can be executed instead of steps S18 and S19. Note that it is preferred to execute the lottery of the admission ticket by the server apparatus 2. After a predetermined condition(s) for executing the lottery is satisfied, the lottery of the admission ticket is executed by operation on the user terminal 1 or when it is detected in the server apparatus 2 that the predetermined condition has been satisfied.

If the user does not own the admission ticket and, as a result of the lottery of the admission ticket, wins the admission ticket, the admission ticket is provided to the user. More specifically, the information of the admission ticket is stored in the user terminal 1 or the server apparatus 2 in association with the user ID. If the user already owns the admission ticket and, as a result of the lottery of the admission ticket, wins the admission ticket, in other words, if the plurality of admission tickets is won by the single user, the already acquired admission ticket and the won admission ticket are compared with each other, the admission ticket of a higher rank is stored in the user terminal 1 or the server apparatus 2, and the won result is displayed by the user terminal 1. Also, if the user does not own any admission ticket and have not acquired the admission ticket in the lottery, the information of the admission ticket is not stored in the user terminal 1 or the server apparatus 2 in association with the user ID.

The process of comparing the ranks of the admission tickets is executed, for example, by comparing the admission ticket numbers. Specifically, in a case in which the smaller the number, the higher the rank of the seat, wherein the admission tickets are associated with the seat numbers, if the admission ticket number acquired this time is “300” and the won admission ticket number is “10” as a result of the lottery, it can be judged that the admission ticket with the number “10” has a higher rank. Therefore, in the user terminal 1 or the server apparatus 2, a process of storing the won admission ticket with the number “10” in association with the user ID and deleting the information of the previously acquired admission ticket with the number “300” is carried out. Also, the previously acquired admission ticket with the number “300” is returned to the lottery denominator of the admission ticket.

Note that, regarding the admission ticket, the admission ticket with a predetermined number or less may be configured to ensure admission to the event. For example, only the admission ticket with the admission ticket number of “200” or less may be configured to allow admission to the event. Also, the ranks of the seats of the admission tickets may be set, for example, as “S”, “A”, “B”, “C”, and “admission not allowed” in descending order, and the ranks of the seats may be mutually compared to store the admission ticket of the higher rank in the user terminal 1 or the server apparatus 2 in association with the user ID.

Note that, also in the case in which a plurality of entries to the lottery of the admission ticket is made at one time, the lottery can be processed in a manner similar to that described above. The results of the lottery are subjected to comparison in the server apparatus 2, and only the admission ticket with the highest rank is stored in the user terminal 1 or the server apparatus 2 in association with the user ID. Alternatively, if a plurality of admission tickets is won, the lottery results may be displayed by the display screen of the user terminal 1, and one of the admission tickets the user wants may be selected. When operation to input the selection is carried out, only the selected admission ticket is stored in the user terminal 1 or the server apparatus 2 in association with the user ID.

Note that, the method of the lottery can employ a lottery method such as a standard lottery, which operates the administrator terminal 3 to set an entry period and a lottery date, carries out a lottery process on the set date with respect to all the users who have entered the lottery, and determines a winner(s), or a real-time lottery, which operates the administrator terminal 3 to set an entry period, the expected number of entries on the first day, and the expected number of entries on the last day and displays lottery results in real time. In the case in which the standard lottery is employed, regarding the admission tickets which have been returned to the lottery denominator as a result of the lottery right comparison, the lottery process may be carried out after the set lottery date until all of the admission tickets are distributed to the users.

Note that the lottery process of the admission tickets is preferred to be carried out by the real-time lottery method at the timing when the product is purchased or at any timing between steps S12 to S20. As a result, the user can confirm the lottery result of the admission ticket at the same time when the purchased product is displayed.

Note that, although the process of judging the presence/absence of the admission ticket in the user terminal 1 is carried out in above described step S18, step S18 may be omitted, and the adding process of the admission ticket may be carried out in step S19. In other words, the configuration in which the plurality of admission tickets is stored in association with the single user ID with respect to the single event can be also employed. Also, regarding the number of the admission tickets, an upper limit of the acquired number may be provided. In such a case, in step S18, whether the upper limit of the admission tickets has been reached or not can be judged. If the upper limit of the admission tickets has not been reached (YES in step S18), addition of the admission ticket is executed.

If the plurality of admission tickets is owned with respect to the single event, the admission ticket is preferred to function as a lottery ticket for participation in the event instead of ensuring participation in the event. The lottery method can appropriately incorporate the above described lottery method of admission tickets.

Furthermore, depending on the predetermined information about the purchase of the product or the predetermined information about admission to the event, the rank of the seat in the event or the type of the seat of the event may vary. Specifically, depending on the number of the admission ticket(s) or the number of product purchases, the rank of the seat may be changeable to a higher rank, for example, from B to A or A to S. Also, depending on the number of the admission tickets or the number of product purchases, the position and the type of the seat such as a specific seat, the left side or the right side of the venue, etc. may be designated by operation on the user terminal 1.

In the above description, the volume added to the number of product purchases, the benefit ticket(s) owned by the user, the admission ticket(s), and/or the number of allowed transmissions of the gift(s) is preferred to be the same as the number of product purchase(s) included in the product purchase request transmitted from the user terminal 1. Alternatively, a threshold value about the purchase money amount may be provided, the total of the money amount used to purchase the product may be calculated in the user terminal 1 or the server apparatus 2, and a predetermined volume may be added based on excess of the money amount over the threshold value; or a predetermined volume may be added every time the money amount exceeds a predetermined money amount.

As described above, since the product information includes the content information and the product benefit information, a price with an added price can be set compared with the case in which the content is individually sold. It is preferred that the content can be individually purchased, while the benefit ticket, the admission ticket, and/or the digital benefit included in the product benefit information cannot be individually purchased.

Note that the content information and/or the product benefit information included in the product information is arbitrarily set by operation on the administrator terminal 3 by the administrator. In the system, when the number of the user terminals 1 to which the information about admission to the event is to be sent is input by operation on the administrator terminal 3, the transmission can be carried out with the product information including the information about the admission until the number of the user terminals 1 to which the information about admission to the event has been transmitted reaches the input number of the user terminals 1. For example, the total number of the benefit tickets, the admission tickets, and/or the digital benefits included in the product benefit information to be distributed is set, and the product benefit information can include the benefit tickets, the admission tickets, and/or the digital benefits until the total number is reached. Specifically, in the case in which 100 admission tickets are to be issued, the user terminal 1 of the user who has made a 101th or subsequent purchase can be configured not to include the admission ticket.

Examples of the things which can be set by the administrator include: various distribution limits such as upper limits of the distribution number of the details of the product benefit information, the benefit tickets, the admission tickets, and/or the digital benefits; the lottery method of the admission tickets; the lottery method using the benefit tickets; usage limits of the content information or the product benefit information; limits on the number of product purchases; and the method of adding the product benefit information. It is preferred that the settings of the product information can be edited, for example, until the release date of the product. Also, even after the product is released, the product benefit information can be configured to be settable in consideration of, for example, the sales trend of the product.

The setting of the product information is carried out by operating the administrator terminal 3 of the administrator, but a representative of the product can input the product information, and the final administrator can approve it. General digital signature or timestamp can be used for the approval. It is preferred that the product information cannot be edited after the approval. Also, regarding the product for which the release date is set, the product may be sellable without approval.

Note that an identification number (also referred to as a token) stored in association with the product is preferred to be provided to the product purchased by the user. The token is a unique identification number linked to a single product and is provided every time the product is purchased. More specifically, even when the same product is purchased, the identification number of the product purchased for the first time and the identification number of the product purchased for the second time are different from each other. Also, a serial code may be provided. As the identification number of the product, a Non Fungible Token (NFT) may be provided. By virtue of this, the ownership of the product can be proved, and tampering of the product information can be prevented.

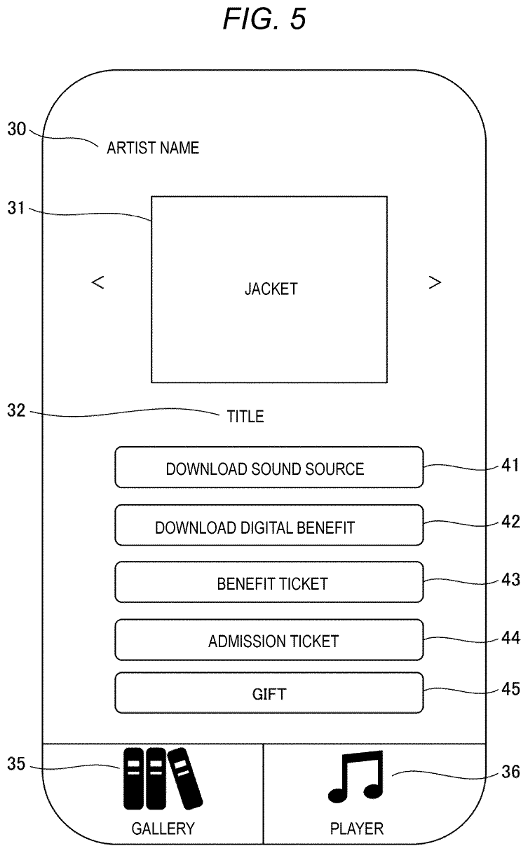

Next, display of the purchased product on the display screen will be described. Regarding a predetermined product, when the product information of the product is received for the first time by the user terminal 1, a screen of the purchased product is generated. FIG. 5 is a diagram illustrating an example of the display screen of the purchased product according to an embodiment of the present invention and illustrates an example of the display screen displayed in step S21. Note that, in the embodiment of the present invention, the product which can be purchased by the user is also referred to as a digital package.

As illustrated in FIG. 5, the details of the product information included in the purchased product are displayed on the display screen and can be confirmed as a list. As the details of the product information, for example, an artist name 30, an image 31 of the product jacket, a title 32 of the product, a sound source download icon 41, a digital benefit download icon 42, a benefit ticket icon 43, an admission ticket icon 44, a gift icon 45, etc. are displayed. Also, the display screen may display icons associated with the functions of the dedicated app such as a gallery icon 35 and a player icon 36. When the gallery icon 35 is pressed, a screen displaying, by a list, the information, benefit ticket, admission ticket, etc. about the digital package is displayed. Note that, in the case of the product in which the information of the details of the icons is not attached to the product information, it is preferred that the icons cannot be pressed.

The artist name 30 is the name of the artist who has produced the product. The image 31 of the product jacket may be an image or a video showing the product. The title 32 of the product shows the name of the purchased product. Also, the product information of another product stored in the user terminal 1 can be displayed by pressing a button displayed in the right side or the left side of the image 31 of the product jacket. Switching of the display to the other product may be carried out by swiping the periphery of the image 31 of the product jacket to the right or the left.

When the sound source download icon 41 is pressed, a screen which allows downloading of the sound source, which is the content information of the purchased product, is displayed. If a plurality of sound sources is included in the content information, all the sound sources may be downloaded, or only an arbitrary sound source(s) may be downloaded. The downloaded sound source(s) is stored in the player in the dedicated app. When the user presses the player icon 36, the player in the dedicated app is displayed. The player in the dedicated app enables the user to use contents such as the sound source stored, for example, by downloading in the user terminal 1. The player displays tabs of respective items such as artist names, albums, songs, playlists, and recently added items. When each tab is pressed, the downloaded songs included in the tab are displayed. The user can view/listen to the downloaded sound source of the purchased product by the player in the dedicated app.

Also, in the system of the present invention, the user can similarly use the contents, which have been download by the dedicated app, by another application stored in the user terminal 1. Specifically, if a download sound source stored in the dedicated app is desired to be reproduced by another music reproducing application (hereinafter, referred to as a music reproducing app) registered in the user terminal 1, the user presses an icon displaying, for example, “reproduce by another music player” by the dedicated app. When the input is received, the other music reproducing app(s) registered in the user terminal 1 is detected, and a list of the music reproducing apps which can transmit sound sources is generated.

Next, the user selects an arbitrary music reproducing app from the list of the other music reproducing apps displayed on the display screen. When the selected music reproducing app is activated, the content information downloaded by the dedicated app is transmitted to the music reproducing app. Thus, the contents downloaded by the dedicated app of the user terminal 1 can be used also by the other music reproducing app. The user can use the contents, which have been acquired by the dedicated app, by the other music reproducing app(s), which he/she likes.

Note that the contents transmitted from the dedicated app to the other music reproducing app may be all the contents stored in the dedicated app or may be only particular content(s) selected by the user. Also, it is preferred that the contents downloaded in a later-described gift sending and gift-benefit providing process are configured to be not transmittable to the other music reproducing apps.

It is preferred that, in the case in which the user has already downloaded the sound source or in the case in which downloading is not allowed due to presale or the like, the sound source download icon 41 is configured to be not pressable. In other words, the administrator or the like can arbitrarily set the timing at which downloading the content information can be started. Also, a predetermined period during which downloading the content information can be carried out may be set. By virtue of this, the user can purchase the product including the product benefit information before the content is released. Also, even when there is a period before the contents are released, the user can purchase the product and participate in the event, which is held at the same timing as the product release, by a later-described admission ticket and/or benefit ticket. Note that the contents downloaded by downloading the sound source may be configured not to have viewing/listening limits.

When the digital benefit download icon 42 is pressed, a screen which enables downloading of the digital benefit of the purchased product is displayed. If the product information includes a plurality of digital benefits, it is preferred that the downloadable digital benefits are displayed by a list. Also, not only the digital benefits of the product illustrated in FIG. 5, but also the digital benefits stored in the user terminal 1 may be displayed by a list.

Also, it is preferred that the display is carried out by a mode which shows the download state of each of the digital benefits; for example, objects which have not been downloaded are provided with an icon “not downloaded”, and objects which have already been downloaded are provided with an icon “downloaded”. Also, it is preferred that the digital benefits which are not yet allowed to be downloaded are displayed by a list, but are displayed in a mode such as gray display which can be distinguished from the other downloadable digital benefits. The downloaded digital benefit can be displayed or reproduced by selecting the digital benefit which is desired to be displayed among the digital benefits displayed by the list. Also, the downloaded digital benefits may be configured to be reproducible not only by the dedicated app, but also by the other application(s) of the user terminal 1.

Also, the administrator can arbitrarily set the downloadable timing of the digital benefit by operating the administrator terminal 3. Furthermore, regarding the downloaded digital benefit, a reproducible period may be set, and/or the number of reproduction may be limited. Also, the administrator can set the downloadable digital benefit by operating the administrator terminal 3 depending on the number of product purchases or the total purchase money amount. Also, the digital benefit may be randomly distributed regardless of the number of product purchases or the total purchase money amount. Furthermore, the digital benefits may vary depending on the purchase timing, the store of the purchase, etc. Also, the digital benefit may be able to be reproduced depending on the number of sending the later-described gift to the other user terminal 1.

When the benefit ticket icon 43 is pressed, a screen which enables confirmation of the benefit ticket of the purchased product is displayed. Also, not only the benefit ticket of the product illustrated in FIG. 5, but also the usable benefit tickets stored in the user terminal 1 may be displayed by a list. Details of a usage method of the benefit ticket will be described later.

When the admission ticket icon 44 is pressed, a screen which enables confirmation of the admission ticket of the purchased product is displayed. Also, not only the admission ticket of the product illustrated in FIG. 5, but also the usable admission tickets stored in the user terminal 1 may be displayed by a list. Details of a usage method of the admission ticket will be described later. When the gift icon 45 is pressed, a screen for generating sending information for transmitting the content information such as the sound source of the purchased product to the other user terminal 1 is displayed. A sending information generating process will be described later.

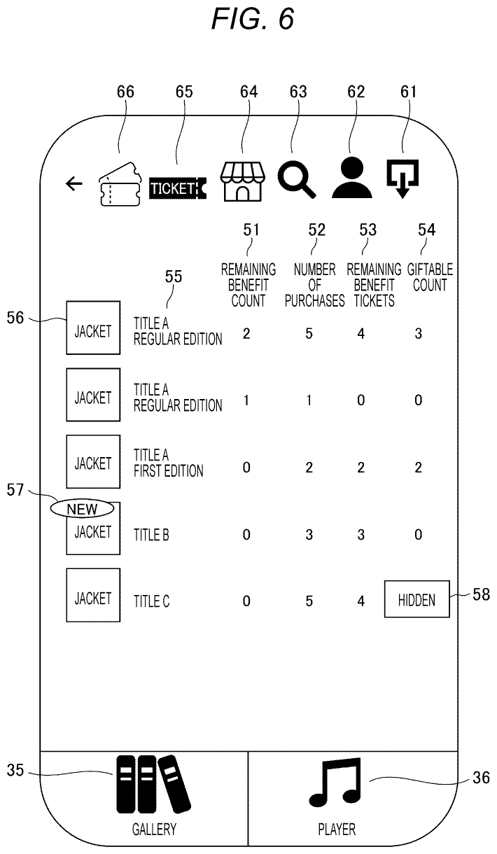

FIG. 6 is a diagram illustrating an example of the display screen of the purchased product list according to an embodiment of the present invention. As illustrated in FIG. 6, the display screen displays, by a list, the products purchased by the user terminal 1 and the details of the product information thereof. As the details of the product information, for example, remaining digital benefit counts 51, the numbers of product purchases 52, remaining benefit ticket counts 53, giftable counts 54, a title 55 of the product, an images 56 of the product jacket, etc. are displayed. Thus, the system can carry out control so as to display, by a list in the user terminal 1, the names of the purchased products, the number of product purchases, the volume of unused benefit tickets, and/or the number of allowed transmissions of part or all of the product information to the other user terminal 1.

Also, the display screen may display an icon which is associated with the functions in the dedicated app or an icon which is associated with websites, for example, a digital-package/gift acquiring icon 61, a my page icon 62, an artist/digital-package search icon 63, a store icon 64, an owned-admission-ticket list icon 65, an owned-benefit-ticket list icon 66, the gallery icon 35 and the player icon 36. When these icons are pressed, the functions are executed, screens are displayed, or transitions to the websites are made, which are associated with these icons.

If the product information received in step S14 includes a digital benefit(s) and a downloadable digital benefit(s) is present, the remaining digital benefit count 51 displays the remaining count of the downloadable digital benefit(s). This is displayed by subtracting the downloaded digital benefit(s) from the digital benefit(s) stored in step S16. Alternatively, the number of the digital benefit(s) which can be downloaded and used by the user may be displayed.

The number of product purchases 52 shows the number of product purchases which has undergone addition in step S15. The remaining benefit ticket count 53 shows the number of the usable benefit ticket(s). This is shown by subtracting the number of the benefit ticket(s) used among the number of the benefit ticket(s), which has been added in step S17. The giftable count 54 shows the number of the gift(s) which can be transmitted to the other user terminal 1. This shows the number obtained by subtracting the number of the transmissions which have already been carried out to the other user terminal 1 and the number of downloading the sound source by the user from the number of allowed transmissions of the gift(s), which has been added in step S20. It is preferred that the titles 55 of the product and the image 56 of the product jacket show those similar to the titles 32 of the product and the image 31 of the product jacket illustrated in FIG. 5.

In the display screen of the product list, it is preferred that the newly added product(s) is displayed in a mode that shows it has been newly added. For example, it is preferred that an icon 57 such as “NEW” is displayed in a vicinity of the jacket image of the newly added product. Also, the product(s) displayed in the product list display can be arbitrarily changed by the user. For example, if a particular product is desired to be hidden, an icon 58 to be hidden can be displayed by swiping a vicinity of the title 55 of the product. When the icon 58 is selected by pressing, the selected product is not displayed in the list. The product can not only be hidden, but also may be configured to be deletable. Also, the order of the products can be arbitrarily changed. It is preferred that the order of the products is displayed in the order of release date and that new products are displayed at a top of the screen.

When the my page icon 62 is pressed, the information about the user who uses the user terminal 1, various settings, terms of use, etc. are displayed. When the artist/digital-package search icon 63 is pressed and an arbitrary character string(s) is input, the artist(s) and digital package(s) stored in the user terminal 1 can be searched. When the store icon 64 is pressed, a list of the stores of EC sites at which products can be purchased is displayed.

### [Benefit Ticket List Display]

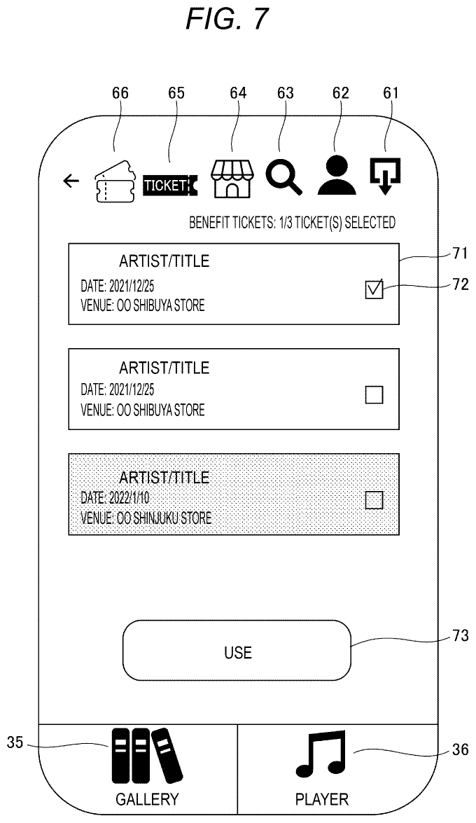

FIG. 7 is a diagram illustrating an example of the display screen of an owned benefit ticket list according to an embodiment of the present invention. This is the screen which is displayed when the above described benefit ticket icon 43 or the owned-benefit-ticket list icon 66 is pressed. As illustrated in FIG. 7, benefit ticket information 71 owned by the user terminal 1 is displayed by a list on the display screen. Also, the benefit ticket information 71 may have checkboxes 72.

It is preferred that the benefit ticket information 71 shows the artist name of the product, a title name, the date of the event, the venue of the event, etc. Also, when the benefit ticket information 71 of each benefit ticket is pressed, further detailed information about the benefit ticket may be displayed. Also, when a serial code is received as a benefit ticket, the benefit ticket information 71 may show the artist name of the product, a title name, the serial code, expiration date, etc.; and, when the benefit ticket information 71 is pressed, the information of the event(s) and benefit(s) to which entries can be made by using the serial code, the information of the site(s) for the entries and lotteries, etc. may be shown.

Also, it is preferred that the benefit ticket information 71 displayed in the list is a usable benefit ticket(s). In other words, the benefit tickets which have already been used and the benefit tickets of past events can be hidden. The benefit ticket information 72 displayed by the list may be displayed in the order of date, and the benefit tickets to be used in future events may be displayed in a mode such as gray display which shows that the benefit tickets cannot be used until the day of the event. Also, regarding the benefit tickets to be used in future events, the checkboxes 72 may be configured to be not pressable.

A process of using the benefit ticket at the event will be described. First, with the user terminal 1, the benefit ticket to be used is selected, and the benefit ticket information of the benefit ticket is displayed on the display screen. Specifically, when an icon 73 showing “USE” is pressed after the checkbox 72 is pressed to select the benefit ticket, the benefit ticket information is displayed. Then, the user presents the benefit ticket information, which is displayed on his/her user terminal 1, to staff of the event venue. The staff confirms the benefit ticket information displayed on the display screen and then carries out input operation on the user terminal 1. Examples of the input operation include: pressing the “USE” button displayed on the display screen again; swiping the display screen upward, downward, leftward, or rightward; displaying a plurality of icons and pressing and swiping the icons at the same time; and displaying a predetermined two-dimensional code on a terminal operated by the staff and reading the code by the user terminal 1. Input by erroneous operation can be prevented by setting complex input operation.

Then, when the input operation is received by the user terminal 1, the information that the benefit ticket has been used is stored in the user terminal 1 and/or the server apparatus 2. Once the information that the benefit ticket has been used is stored, the user terminal 1 can no longer select the benefit ticket and display the benefit ticket information of the benefit ticket on the display screen again. In other words, the benefit ticket becomes an unusable state. By virtue of this, multiple-times usage of the same benefit ticket can be prevented. Also in the case in which re-display of the benefit ticket information is not limited, it is preferred that the information is displayed in a mode which shows that the information is in an already used state; for example, the benefit ticket stored with the information that it has already been used displays a word “DONE”, or the display of “USE” is changed to black.

Note that the above described input operation by the staff or the like may be input by the user under the supervision of the staff. Also, instead of the input operation by the staff or the like, a two-dimensional code having the identification information of the selected benefit ticket may be generated, and the code may be displayed by the user terminal 1. In such a case, when a terminal operated by the staff or the like reads the two-dimensional code and transmits the information to the server apparatus 2, the server apparatus 2 and/or the user terminal 1 can specify the benefit ticket and store the fact that the benefit ticket has been used. Note that, in the embodiment of the present invention, QR code (registered tradename) can be used as the two-dimensional code.

A plurality of benefit tickets to be used at the event may be selected. The display screen can display the number of selection, for example, “⅓ TICKETS SELECTED”. When the plurality of benefit tickets is selected, pop-up screens such as “POSTER PRESENT”, “YOU CAN SHAKE HANDS”, and “YOU CAN TAKE PHOTOGRAPHS” may be displayed depending on the selected number of tickets so that the user can confirm the options enabled by the benefit tickets for the user to execute at the event. In other words, the variety of options which can be executed by the user at the event is displayed by the user terminal 1 in an understandable mode.

Furthermore, one or a plurality of the benefit tickets may be selected so that the user can make an entry(ies) to a lottery(ies) of executable options and other benefits. In other words, in the system, depending on the predetermined information about the product purchases, the predetermined information about admission to the event, or the predetermined information about the benefits related to the content information, a lottery(ies) about the benefit(s) related to the content information may be carried out. In such a case, the lottery method using the benefit ticket can appropriately incorporate the lottery method such as the above described standard lottery or the real-time lottery.

In the case of the benefit ticket with which an entry to a lottery can be made, it is preferred that the benefit ticket information 71 shows the artist name of the product, the title name, the details of the lottery to which an entry can be made, entry conditions, entry deadline, etc. Also, it is preferred that the display screen of the benefit ticket list displays the benefit ticket information of the lottery result. If one or a plurality of the benefit tickets is selected, a pop-up screen that “ENTRY TO COUSE A CAN BE MADE” may be displayed depending on the selected number of tickets so that the course(s) of the lottery to which entry can be made with the selected benefit ticket(s) is confirmed by the user. In other words, the variety of the lotteries to which entries can be made is displayed by the user terminal 1 in an understandable mode.

### [Admission Ticket List]

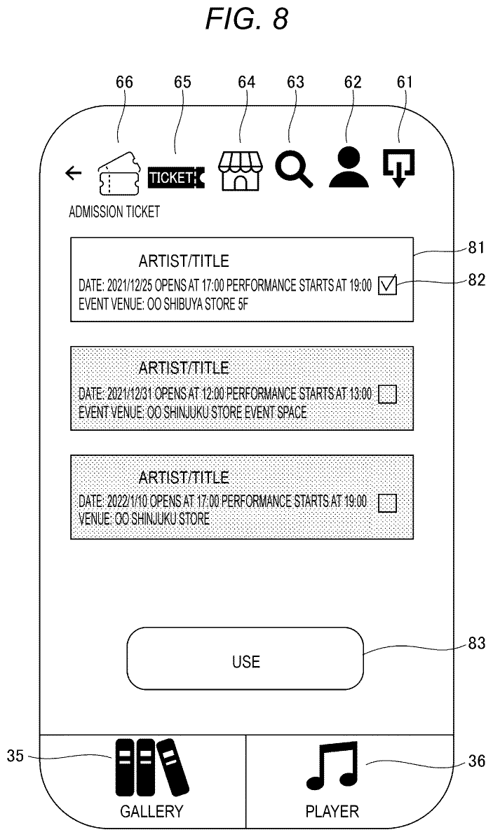

FIG. 8 is a diagram illustrating an example of the display screen of an owned admission ticket list according to an embodiment of the present invention. This is the screen which is displayed when the above described admission ticket icon 44 or the owned-admission-ticket list icon 65 is pressed. As illustrated in FIG. 8, admission ticket information 81 owned by the user terminal 1 is displayed by a list on the display screen. Also, the admission ticket information 81 may have checkboxes 82.

It is preferred that the admission ticket information 81 describes the artist name of the product, the title name, the date of the event, venue-opening/performance-starting time, the venue of the event, etc. Alternatively, the date of the event, the venue-opening/performance-starting time, the venue of the event, etc. are not shown by the admission ticket information 81, but may be displayed when the admission ticket information 81 is pressed. Also, when a serial code is received as an admission ticket, the admission ticket information 81 may show the artist name of the product, the title name, the serial code, expiration date, etc. As described above, it is preferred that, when the admission ticket information 81 is pressed, the information of the event and benefit to which an entry can be made, the information of a site for the entry or lottery, etc. which is available by using the serial code are displayed.

Also, it is preferred that the admission ticket information 81 displayed in the list is a usable admission ticket(s). In other words, the admission tickets which have already been used and the admission tickets of past events can be hidden. The admission ticket information 81 displayed by the list may be displayed in the order of date, and the admission tickets to be used in future events may be displayed in a mode such as gray display which shows that the admission tickets cannot be used until the day of the event. Also, regarding the admission tickets to be used in future events, the checkboxes 82 may be configured to be not pressable.

A process of using the admission ticket at the event will be described. The process of using the admission ticket can incorporate the above described process of using the benefit ticket at the event, wherein the benefit ticket is replaced by the admission ticket. Therefore, redundant part will be appropriately omitted. First, with the user terminal 1, the admission ticket to be used is selected, and the admission ticket information of the admission ticket is displayed on the display screen.

Then, the user presents the admission ticket information, which is displayed on his/her user terminal 1, to staff of the event venue. The staff confirms the admission ticket information displayed on the display screen and then carries out input operation on the user terminal 1. When the input operation is received by the user terminal 1, the information that the admission ticket has been used is stored in the user terminal 1 and/or the server apparatus 2. Once the information that the admission ticket has been used is stored, the user terminal 1 can no longer select the admission ticket and display the admission ticket information of the admission ticket on the display screen again. In other words, the admission ticket becomes an unusable state. By virtue of this, multiple-times usage of the same admission ticket can be prevented.

Note that it is preferred that the admission ticket(s) displayed by the owned admission ticket list are the admission ticket(s) which ensure admission to the event(s). Also, it is preferred that, if there is an admission ticket with which an entry to a lottery has been made regarding an event in which the user wants to participate, an icon such as “DURING LOTTERY” is displayed on the admission ticket information 81. Also, it is preferred that, if the right of the admission to the event is not acquired as a result of the lottery, the admission ticket information is not displayed. In other words, the display mode of the admission ticket information 81 can be changed depending on the status of the lottery.

When entries to a lottery (ies) of an event(s) are to be made or when a seat can be selected depending on the number of admission tickets, a plurality of admission tickets can be selected. The display screen can display the number of selection, for example, “⅓ TICKETS SELECTED”. When the plurality of admission tickets is selected, a pop-up screen such as “SEAT B CAN BE CHANGED TO SEAT A” or “PREFERRED SEAT CAN BE SELECTED” may be displayed. In other words, the variety of admission tickets which can be acquired by the user at the event is displayed by the user terminal 1 in an understandable mode.

Note that the above described benefit tickets and the admission tickets are stored in the user terminal 1 and/or the server apparatus 2 in association with the user ID and may be configured to be not transmittable to the other user terminal 1. Also, the benefit tickets and/or the admission tickets may be configured to be transmittable to the other user terminal 1. In such a case, personal information of the user who operates the other user terminal 1, which is a destination of the gift, may be input before the transmission, or the gift may be transmitted only to the other user terminal for which the personal information has been input. Also, the number of the benefit tickets and/or the admission tickets to be transmitted may be limited. Sending of the product benefit information including the benefit ticket and/or the admission ticket will be described in detail in the later-described sending information generating process and the gift sending and gift-benefit providing process.

### [Sending Information Generating Process]

The gift sending function, which can transmit part or all of the product information to the other user terminal depending on the number of provision depending on the predetermined information about the product purchase, will be described. The sending information generating process described below is a process for the user who has purchased the product to generate the sending information, which transmits part or all of the purchased product information, after execution of the product information transmitting process.

Note that, the following will mainly describe a configuration in which the content information is transmitted to the other user terminal as the gift, but can be also applied to a case in which the product benefit information is transmitted to the other user terminal as the gift. Also, hereinafter, the user terminal operated by the user of a sender of the gift is a user terminal 1a, and the other user terminal operated by the user who receives the gift is a user terminal 1b.

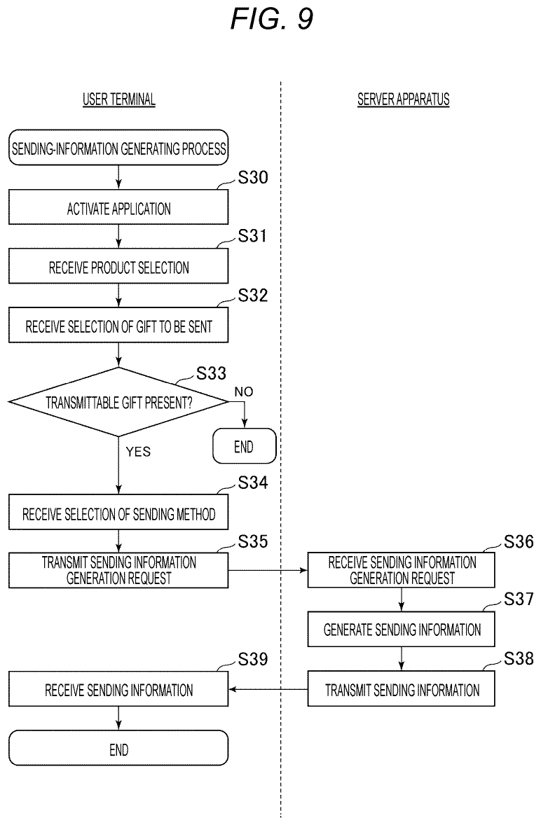

FIG. 9 is a diagram illustrating a flow chart of the sending information generating process according to an embodiment of the present invention. First, operation by the user activates the dedicated app in the user terminal 1a (step S30). When the user selects the product for which the user wants to send the gift, the selection of the product is received by the user terminal 1a (step S31). When the user terminal 1a receives the selection of the product, the display screen of the product illustrated in FIG. 5 is displayed. When the user presses the gift icon 45, the selection of the gift to be sent is received by the user terminal 1a (step S32).

Then, the user terminal 1a judges whether the transmittable gift is present or not (step S33). Note that the judgement whether the transmittable gift is present or not may be carried out by the server apparatus 2. If the transmittable gift is not present (NO in step S33), the process is terminated. Note that it is preferred that, if the transmittable gift is not present, the gift icon 45 cannot be pressed. If the transmittable gift is present (YES in step S33), the selection of a sending method is received (step S34). The sending method is not particularly limited, but the sending can be carried out via face-to-face, a mail, or various SNS.

Herein, if the number of the transmittable gifts is two or more, the user inputs the number of the gifts to be transmitted. When the selection of the sending method and the number of the gifts to be transmitted is received in step S34 by the user terminal 1a, the sending information generation request is transmitted from the user terminal 1a to the server apparatus 2 (step S35). When the sending information generation request is received by the server apparatus 2 (step S36), sending information is generated (step S37). The sending information is transmitted from the server apparatus 2 to the user terminal 1a (step S38), and the sending information is received by the user terminal 1a (step S39). The received sending information is stored in the storage 13 of the user terminal 1a. Through the processes of steps S30 to S39, the sending information generating process is terminated. Note that step S34 may be omitted.

The “sending information” herein is the information for the user to transmit part or all of the product information, which corresponds to the purchased product, to the other user terminal 1b operated by the other user. The sending information may include gift identification information for specifying later-described gift information and the information (for example, a predetermined character string) with which the user identification information for identifying the user who is the sender of the gift can be specified, and/or a two-dimensional code which enables acquisition, by decoding, of the information with which the gift identification information and the user identification information can be specified. After the dedicated app is activated, the gift information and the user who is the sender of the gift can be specified by selecting or inputting the predetermined character string or the two-dimensional code.

Alternatively, the sending information may include a URL with which the gift information can be specified or include a two-dimensional code which can be acquired by decoding the URL. With the URL, the other user can access a website for receiving the gift information. In such a case, different URLs are set respectively for the gift information and the users who are the senders. When one of the URLs is accessed, the gift information corresponding to the URL can be provided to the other user. The dedicated app may be activated when the URL is accessed.

The server apparatus 2 transmits the gift information, which has been specified by the sending information, to the other user terminal 1b, which has received the selection or input of the sending information. In other words, the other user can receive the gift by selecting or inputting the sending information by the other user terminal 1b. Therefore, when the user generates the sending information, the information of the other user or the other user terminal 1b, which is the destination, is not required to be input, in other words, the counterpart to which the gift is sent is not required to be specified. Therefore, the user can easily generate the sending information. Also, gifts can be transmitted to more other users, and dissemination of secondary information can be expected.

Herein, part or all of the product information transmitted to the other user terminal 1b is referred to as “gift information”. When the content information is to be transmitted to the other user terminal 1b as the gift, the gift information includes the information of the contents such as the sound source selected by the user in step S32. In such a case, the gift information may include the sound source information only or may include related contents such as lyrics text, a lyrics card image, and a jacket image.

Note that a predetermined usage limit(s) may be set on the contents transmitted to the other user terminal 1b by the gift sending function. For example, the contents transmitted to the other user terminal 1b by the gift sending function may be configured to be reproducible in the dedicated app, be reproducible in the terminal which has received the gift information, have a limit on the transmission of the gift information to another terminal, be able to reproduce only part of the contents, or be prohibited to copy the gift information.

Alternatively, for example, the contents transmitted to the other user terminal 1b by the gift sending function may be configured to be reproducible only by a predetermined number or may be configured to be reproducible only in a predetermined period. In other words, part or all of the product information transmitted to the other user terminal 1b may be usable in the other user terminal 1b with a limit of a predetermined period or by a predetermined number of times.

Note that the information received in step S39 includes the information, which is displayed when the sending information is transmitted to the other user terminal 1b, depending on the sending method selected in step S34. Other than the two-dimensional code and/or the URL, examples thereof include the artist name included in the gift information, the title, a download URL of the dedicated app, etc.

The two-dimensional code and/or the URL included in the sending information received in step S39 may be displayed by the display screen of the user terminal 1a. For example, if the gift is to be sent to the other user by face-to-face, the generated two-dimensional code may be displayed on the display screen of the user terminal 1a. Also, for example, if the gift is to be sent to the other user by a messaging app, the messaging app is activated, and a screen (hereinafter, also referred to as a message editing screen), which is in a state including the generated two-dimensional code and/or the URL and is for editing the details of messages, may be displayed. On the message editing screen, the user can input a message and the information of the destination and transmit the message including the sending information.

Also, for example, if the sending information is to be posted on SNS, a SNS application is activated, and a screen (hereinafter, also referred to as a post editing screen), which is in a state including the generated two-dimensional code and/or the URL and is for editing the details of the post, may be displayed. On the post editing screen, the user can input text and post a post including the sending information. In the case in which SNS is used, the gift can be sent without designating a counterpart. In other words, another arbitrary user(s) who has seen the post of the user can receive the gift.

Herein, the judgement of YES is made in step S33 when the number of the transmittable gift(s) is one or more. More specifically, this is the case when one or more is displayed as the giftable count 54. The number of the transmittable gift(s) matches the number displayed as the giftable count 54. The giftable count 54 is the number obtained by subtracting the number of transmission of the gifts to the other user terminal 1b from the number of allowed transmission of the gift, which has been added in step S20. Also, as management of the giftable count 54, the giftable count 54 may be managed by setting a flag for one gift and deleting the flag every time the gift is transmitted. In other words, in the system of the present invention, part or all of the product information is transmitted to the other user terminal 1b only by the predetermined number of transmission(s), and it is preferred that the predetermined number of transmission(s) is the number provided depending on the predetermined information about the product purchase(s).

Alternatively, the giftable count 54 may be the number obtained by subtracting the number of downloads of the sound source included in the content information in the user terminal 1a and the number of transmissions of the gift to the other user terminal 1b from the number of allowed gift transmissions added in step S20. Thus, if the number of product purchase is one, if the user executes either downloading of the sound source or the sending information generating process, downloading of the sound source and the sending information generating process cannot be carried out thereafter. Alternatively, the addition of the giftable count may be carried out from the second purchase of the product. In such a configuration, the user can always execute downloading of the sound source at least one time.

Note that, when the number of the gift(s) to be sent is input in step S34 and the sending request is transmitted in step S35, the number of the transmittable gift(s) becomes the number which is obtained by subtracting the input number of the gift(s) from the number of the transmittable gifts in step S33. In other words, the ownership of the contents included in the gift information is removed from the user when the sending information generation request is transmitted in step S35. The ownership is once transferred to the administrator of the system and is then transferred, by the gift sending and gift-benefit providing process, to the user who has carried out the receiving operation of the gift. Note that, in the system of the present invention, the user who sends the gift cannot return the gift, which has been sent in the sending information generating process, to his/her own number of allowed gift transmissions again, but the user can receive the gift, which has been sent in the sending information generating process, by himself/herself and use the gift.

Note that the sending information may have part of the gift information in addition to the two-dimensional code and/or the URL with which the gift information can be specified. Part of the gift information may be the content information which can be reproduced by an application other than the dedicated app. For example, if the gift enables downloading of the sound source, part (for example, 15 seconds of the song) of the sound source may be part of the gift information.

Specifically, the part of the gift information is automatically determined by the server apparatus 2 in step S37 in accordance with a predetermined position and predetermined time set in advance for starting reproduction of the contents. For example, if it has been set to generate the part of the gift information which is 15 seconds from the position of 0 second of the contents, when the gift is selected in step S32, the part of the gift information is generated for the 15 seconds from the 0 second of the contents. Alternatively, in step S34, the user can select arbitrary part of the contents by operating the user terminal 1a to generate the part of the gift information. However, it is preferred that the reproducible time such as 15 seconds is determined for the arbitrary part which can be selected by the user.

Also, the part of the gift information may include the content information such as images and videos. The other user who has seen, by SNS or the like, the post of the user including the above described generated two-dimensional code and/or URL can view/listen to the part of the gift information before downloading the gift since the part of the gift information can be reproduced by another application even if the dedicated app is not download to the other user terminal 1b. If the user wants to acquire the gift after viewing/listening to the part of the gift information, the user can download the dedicated app to the user terminal 1b of his/her own and carry out the later-described gift sending and gift-benefit providing process. Note that the part of the gift information may be configured to be unusable once all the downloadable gift(s) is consumed, or usage limit is not required to be provided.

### [Gift Sending and Gift-Benefit Providing Process]

Next, the gift sending and gift-benefit providing process will be described. The gift sending and gift-benefit providing process is a process of transmitting the gift information to the other user terminal 1b when the sending information is selected or input by the other user terminal 1b after the sending information is generated in the sending information generating process. Also, this is the process of registering that a predetermined benefit(s) is to be provided to the user and/or the other user when the predetermined condition is satisfied and/or determining the predetermined benefit(s) to be provided to the user and/or the other user when the predetermined condition is satisfied.

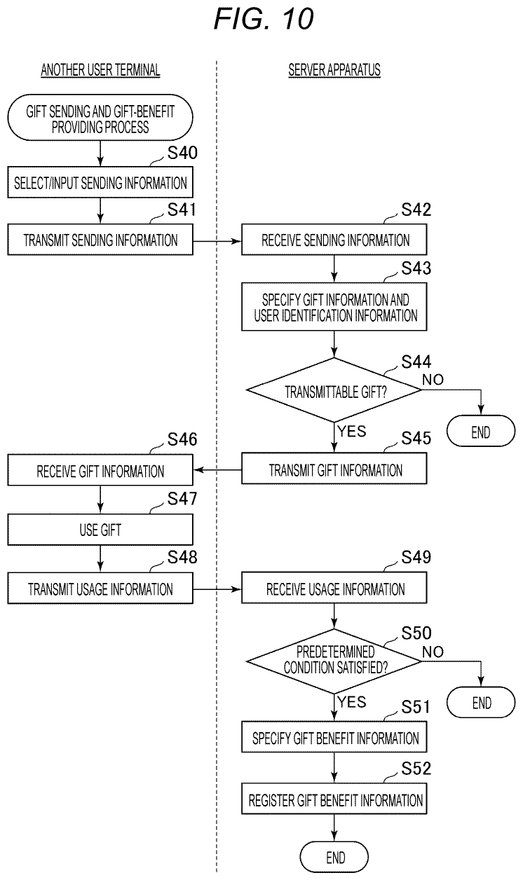

FIG. 10 is a diagram illustrating a flow chart of the gift sending and gift-benefit providing process according to an embodiment of the present invention. First, selection or input of the sending information is executed on the other user terminal 1b by operation by the other user (step S40).

When the selection or input of the sending information is executed on the user terminal 1b, the selected or input sending information and the user identification information of the other user terminal 1b is transmitted to the server apparatus 2 (step S41). When the sending information is received by the server apparatus 2 (step S42), the gift information corresponding to the sending information and the user identification information of the sender is specified (step S43).

Herein, if the sending information is the predetermined character string and/or the two-dimensional code, the input of the sending information may be carried out after the dedicated app is activated. For example, first, the dedicated app is activated by the other user terminal 1b. Then, the other user presses the digital-package/gift acquiring icon 61, which is displayed on the display screen of the dedicated app. Then, when the other user captures the two-dimensional code or inputs the predetermined character string, which has been presented by the user who generated the sending information, the input of the sending information is executed. Alternatively, the other user may execute the input of the sending information by activating the dedicated app and then selecting an image of the two-dimensional code, which is posted on SNS or the like saved in the other user terminal 1b in advance.

Note that, if the sending information is a URL or the like, the input of the sending information may be carried out before the dedicated app is activated. In other words, the following process may be executed instead of steps S40 to S43. For example, the other user selects the URL posted on the SNS or the like and accesses a screen or a website on which the gift information can be confirmed. Alternatively, the other user may access a screen or a website from which transmission of the gift information can be applied for. When the other user applies for the transmission of the gift information via the screen or the website, the gift information corresponding to the URL and the user identification information of the sender is specified in the server apparatus 2.

Moreover, when the other user applies for the transmission of the gift information, presence/absence of download of the dedicated app in the user terminal 1b may be judged. If the dedicated app has been downloaded to the user terminal 1b, the dedicated app is activated in the user terminal 1b. If the dedicated app has not been downloaded to the user terminal 1b, a screen which prompts the user to download the dedicated app is displayed by the user terminal 1b. When the dedicated app is activated, the user identification information of the other user terminal 1b is transmitted to the server apparatus 2.

Then, in the server apparatus 2, whether the specified gift information is transmittable to the user terminal 1b or not is judged (step S44). If the gift information is not transmittable to the user terminal 1b (NO in step S44), the gift sending and gift-benefit providing process is terminated.

On the other hand, if the gift information is transmittable to the user terminal 1b (YES in step S44), the gift information is transmitted to the user terminal 1b (step S45). The transmitted gift information is received by the user terminal 1b (step S46). As a result, in the user terminal 1b, the contents such as a sound source included in the gift information can be used, for example, by downloading. Also, it is preferred that, in the server apparatus 2, the sent gift information, the user identification information of the sender, and the other user identification information of the destination is mutually associated and stored.

Note that the process of step S44 can be executed in a following manner. In the embodiment of the present invention, the number of allowed transmissions of the gift information from the server apparatus 2 to the user terminal 1b by using the single sending information is limited to the number of the gift(s) input in step S34. Thus, in step S44, whether the specified gift information satisfies the predetermined condition about the gift information or not may be judged. Examples of the predetermined condition about the gift information include whether the number of receptions of the sending information in step S42 has reached the number of the gift(s) input in step S34 or not. If the predetermined condition is satisfied, the gift information is not transmitted.

Therefore, in step S42, if the number of reception of the sending information is equal to or more than the number of the gift(s), which has been input in step S34, at the point when the sending information is received, it is judged that the gift information cannot be transmitted to the user terminal 1b. On the other hand, in step S42, if the number of reception of the sending information is less than the number of the gift(s), which has been input in step S34, it can be judged that the gift information can be transmitted to the user terminal 1b. For example, if the same or the plurality of user(s) transmits the same sending information to the server apparatus 2, the gift information is transmitted from the server apparatus 2 to the user terminal 1b until the input gift number is reached.

Also, the gift information may be configured to be transmittable to the other user terminal 1b to which the dedicated app has been downloaded. Also, furthermore, the judgement in step S44 of whether the specified gift information is transmittable to the user terminal 1b or not may judge whether the predetermined condition about the other user who transmits the gift information is satisfied or not or may judge whether another predetermined condition(s) about the gift information is satisfied or not.

Examples of the predetermined condition about the other user include the user who has generated the sending information, the user who has been set in advance by the administrator, the user who has received the gift information a predetermined number of times or more, etc. Examples of the other predetermined condition about the gift information include a fact that it is a predetermined period outside a sales period of the product related to the gift information, a fact that it is a predetermined period outside the generation of the sending information, etc. If the other predetermined condition about the gift information is provided, the information about time is transmitted to the server apparatus 2 together with the sending information in step S41.

The gift information is received in step S46. Then, when the gift information is used by the user terminal 1b (step S47), the usage information including that the gift has been used by the user terminal 1b is transmitted from the user terminal 1b to the server apparatus 2 (step S48). Examples of the usage of the gift information include downloading part or all of the received gift information, making an entry to a lottery if the gift information has a lottery function, etc.

When the usage information is received by the server apparatus 2 (step S49), a gift benefit table registered in the server apparatus 2 in advance is referenced, and whether the predetermined first condition and/or the predetermined second condition for providing the gift benefit information is satisfied or not is judged (step S50). If the predetermined first condition and/or the predetermined second condition is not satisfied (NO in step S50), the benefit providing process is terminated.

On the other hand, if the predetermined first condition and/or the predetermined second condition is satisfied (YES in step S50), the gift benefit table is referenced, and the first benefit provided to the user who is the sender of the gift and/or the second benefit provided to the user who has received the gift is specified (step S51). Then, in the server apparatus 2, the specified first benefit is stored in association with the user who is the sender of the gift, and/or the specified second benefit is stored in association with the user who has received the gift (step S52). As a result, in the server apparatus 2, the fact that the first benefit is provided to the user and/or the fact that the second benefit is provided to the other user is registered. Through the process of steps S40 to S52, the gift sending and gift-benefit providing process is terminated.

Herein, in the gift benefit table, the predetermined first condition for providing the first benefit to the user and the details of the first benefit provided to the user when the first condition is satisfied are stored in association with each other. In the gift benefit table, the predetermined second condition for providing the second benefit to the other user and the details of the gift benefit provided to the other user when the second condition is satisfied are stored in association with each other.

Examples of the predetermined first condition for providing the first benefit to the user or the predetermined second condition for providing the second benefit to the other user include: a fact that part or all of the product information has been transmitted to the other user terminal 1b, a fact that part or all of the received product information has been used by the other user terminal 1b, a fact that input of the information about the benefit to be provided to the user has been received by operation input on the other user terminal 1b, a fact that the number of transmissions of part or all of the product information to the other user terminal 1b is equal to or less than a predetermined number, a fact that the number of transmissions of part or all of the product information, by the user who is the sender, to the other user terminal is equal to or more than a predetermined number, and a fact that the time at which part or all of the product information has been transmitted to the other user terminal 1b is within a predetermined period.

The predetermined first condition or the predetermined second condition may be any one of the above described examples or may be a combination of any two or more of the above described examples. Also, the predetermined second condition may be the same condition as the first condition or may be a different condition.

For example, if the predetermined first condition is the fact that part or all of the product information has been transmitted to the other user terminal 1b, steps S47 to S49 can be omitted, and, when the gift information is received by the user terminal 1b in step S46, it is judged that the predetermined first condition is satisfied. Also, in the case in which the predetermined first condition is the fact that part or all of the received product information has been used by the other user terminal 1b, when the usage information is received by the server apparatus 2 in step S49, it is judged that the predetermined first condition is satisfied.

Also, for example, in the case in which the predetermined first condition is the fact that input of the information about the benefit to be provided to the user is received by operation input on the other user terminal 1b, steps S47 to S49 can be omitted, and, when input of the information about the benefit to be provided to the user is received by the user terminal 1b or the server apparatus 2 by operation input on the other user terminal 1b, it can be judged that the predetermined first condition is satisfied. Note that, in the embodiment of the present invention, the benefit to be provided to the user can be provided, by operation input on the other user terminal 1b, as a point(s) expressing gratitude from the other user who has received the gift to the user who is the sender of the gift. Depending on the degree of gratitude, the provided point can be increased/reduced.

Note that usage of the points is not particularly limited. For example, the points can be used as an actual currency when purchasing products, or the points can be used. For example, the points can be used, depending on the amount of the points, to increase various upper limits, increase a lottery probability by a predetermined rate, or remove various limits.

Also, for example, in the case in which the predetermined first condition is the fact that the number of transmissions of part or all of the product information to the other user terminal 1b is equal to or less than the predetermined number, when the gift information, the user identification information of the other user who has received the gift information, and the number of transmissions of the gift information is stored in association with one another in the server apparatus 2, whether the predetermined first condition is satisfied or not can be judged. If the number of transmissions of the predetermined gift information to the other user terminal 1b is equal to or less than the predetermined number, it can be judged that the predetermined first condition is satisfied. Also, similarly in the case in which the number of receptions of the predetermined gift information by the user terminal 1b is equal to or less than the predetermined number, it can be judged that the predetermined first condition is satisfied. By virtue of this, the gift information can be more actively disseminated to the user who does not know the product related to the gift information or the user with a low number of receptions of the gift information. Note that, in such a case, steps S47 to S49 can be omitted.

Also, for example, in the case in which the predetermined first condition is the fact that the number of transmissions of part or all of the product information, by the user who is the sender, to the other user terminal is equal to or more than the predetermined number, the sent gift information, the user identification information of the sender, and the number of transmissions of the gift information is stored in association with one another in the server apparatus 2. Then, when the number of transmissions of the gift information associated with the user who is the sender is aggregated, whether the predetermined first condition is satisfied or not can be judged. Also, regarding single gift information or the predetermined gift information, if the aggregated number is equal to or more than the predetermined number, it can be judged that the predetermined first condition is satisfied.

Also, for example, in the case in which the predetermined first condition is the fact that the time at which part or all of the product information has been transmitted to the other user terminal 1b is within the predetermined period, when the information about the time at which the gift information is transmitted is stored in step S45, whether the predetermined first condition is satisfied or not can be determined. If the time at which the gift information is transmitted in step S45 is within the predetermined period, it can be judged that the predetermined first condition is satisfied. Also, if time information, the sent gift information, the user identification information of the sender, the user identification information of the destination, and the number of transmissions of the gift information is stored in association with one another in the server apparatus 2 and if the number of storing within the predetermined period is equal to or more than the predetermined number, it can be judged that the predetermined first condition is satisfied.

Herein, the “gift benefit information” stored in the gift benefit table is not particularly limited as long as it is the information about a benefit which prompts the user and/or the other user to transmit part or all of the product information, which corresponds to the product purchased by the user, to the other user terminal 1b, and is not only be the information which can be transmitted to the user terminal and/or the other user terminal, but also may be a tangible object different from information of a prize, a coupon ticket, a currency, or the like. Also, it may be an object related to the content(s) included in the product information or may be an irrelevant object. Also, the first benefit provided to the user and the second benefit provided to the other user may be the same or may be different from each other. Also, the benefit included in the gift benefit information may be a benefit similar to the benefit included in the product benefit information.

Examples of the first benefit and/or the second benefit included in the gift benefit information include: allowance of purchase before predetermined sales date regarding purchase of the predetermined product, allowance of purchase of the predetermined product, allowance of purchase of the predetermined product by increasing the upper limit of the purchasable number of the predetermined product, and/or, regarding a predetermined lottery, allowance of execution of the lottery at a lottery probability which is increased by a predetermined rate. Also, as a benefit, a predetermined point may be provided. Note that, regarding the first benefit or the second benefit, the first benefit or the second benefit may be provided every time the predetermined first condition or the predetermined second condition is satisfied, or the first benefit or the second benefit provided may be changed depending on the degree of satisfying the predetermined first condition or the predetermined second condition.

Note that examples of the predetermined product include a product of the artist included in the gift information and a product of the same agency as the artist included in the gift information. However, the predetermined product is not particularly limited as long as the product is associated with the first benefit and/or the second benefit by the administrator. Also, usage of the predetermined point is not particularly limited, but can be similarly used as the above described point.

A process of enabling the user and/or the other user to make a purchase before the predetermined sales date regarding purchase of the predetermined product will be described. For example, if general sales date is December 1st, registration is made in association with the user ID in the server apparatus 2 that the user to whom the benefit is provided is allowed to make a purchase(s) from November 1st. In such a case, an upper limit of the product to be purchased may be provided.

A process of enabling the user and/or the other user to purchase the predetermined product will be described. For example, if the number of the products to be sold is 5000, 100 products among them can be reserved for the users to whom the benefit is provided. In other words, the sales for general users are terminated when 4900 products are sold, but the users to whom the benefit is provided can purchase the product from among 100 reserved products. Alternatively, even when the number of sales reaches 5000, the users to whom the benefit is provided may be allowed to make additional purchases of the products. Also, for example, the products which can be purchased only by the users to whom the benefit has been provided may be set.

Furthermore, for example, in the case in which the number of allowed transmissions of part or all of the product information to the other user terminal 1b is stored in association with single sending information, the first benefit and/or the second benefit included in the gift benefit information may increase the upper limit of the number of allowed transmissions. Specifically, in the case in which the upper limit is provided for the number of the gift which can be associated with the single sending information in step S34, the number of the gift which can be input can be increased.

### [Digital-Package Acquiring Process]

In the above described embodiment, the mode in which the product is purchased from the EC site of the store in the product information transmitting process of FIG. 4 has been described. However, the system of the present invention can be applied also to a product purchased at a brick-and-mortar store as long as the product includes product information. In such a case, a two-dimensional code or a serial code including identification information which can specify the single product information is attached to the product which can be purchased at the brick-and-mortar store.

In such a case, the digital-package/gift acquiring icon 61 is pressed to acquire a digital package. When a camera of the user terminal 1 is activated and photographs the two-dimensional code or the like attached to the product or when a photograph capturing an image of the two-dimensional code or the like attached to the product is selected, the two-dimensional code or the like is read, and input of the identification information is executed. Alternatively, the information of the serial code may be directly input. The input information of the two-dimensional code or the serial code is transmitted from the user terminal 1 to the server apparatus 2. When the server apparatus 2 specifies the corresponding product information from the identification information included in the received information, the process of steps S13 to S21 is executed.

Note that the product information transmitted in response to the information input from the two-dimensional code or the serial code attached to the actual product may be different from the product information of the product which is purchased via the EC site of the store. For example, a limit may be provided on the sound source downloading or the addition of the gift. Also, the transmission of the product information from the server apparatus 2, which is executed when the two-dimensional code or the like is input, is executed only when the input information is received by the server apparatus 2 for the first time. In other words, if the reception of the input information by the server apparatus 2 is the second or subsequent times, the product information is not transmitted from the server apparatus 2 to the user terminal 1. By virtue of this, transmitting the content information and the product benefit information to the user more than the purchased product can be prevented.

### [Sales Management]

In the embodiment of the present invention, personal information such as a name, the date of birth, a residential prefecture, and gender can be registered as the information of the user in the dedicated app. The information is also referred to as types of the user. Also, the number of purchase and the date of purchase of the product, presence/absence of sound source downloading, and the information about the gift is stored in the server apparatus 2. Therefore, the administrator can aggregate and display the various information about the product by the administrator terminal 3. For example, the total number of the sold products, the number of product purchase(s) per person, the date of purchase of the product, the number of downloads of the sound source by the dedicated app, the number of the gifts sent from the user, the number that the person who has received the gift has used the contents, and the age, gender, residence area, etc. of the purchased user can be managed. By virtue of this, the administrator can easily manage sales status. Also, the administrator can easily confirm a correlation between the event and the number of sales.

In the above described embodiment of the invention, the mode which executes the product information transmitting process, the sending information generating process, and the gift sending and gift-benefit providing process and saves various information in the server apparatus 2 has been described. However, this can be achieved by a distributed ledger technique using blockchain. A blockchain network may be built as a private network or may be built as a public network. The information management by the blockchain maintains security, and the ownership of the user about the digital package is ensured. By virtue of this, unfair resale of the content information and the product benefit information can be prevented. Examples of the information retained in the digital package by the blockchain include a serial code of the digital package per se, a sales channel ID of a seller, a sales channel store ID of a retail store, a user ID, and the price of the digital package.

Also, in the above described embodiment of the invention, the configuration in which the contents are downloaded has been described. However, the contents may be acquired by streaming. Note that, when the contents are acquired by streaming, the number of streaming allowed may be limited as well as the number of downloading allowed.

According to the present invention, part or all of the product information corresponding to the product purchased by the user can be transmitted to the other user terminal. When the sending information is selected or input by the other user terminal, part or all of the product information can be transmitted to the other user terminal. Therefore, when the sending information is generated, the other user who is the destination of part or all of the product information is not required to be designated. Therefore, regarding the product purchased by the user, increase in fan base can be expected since the transmission to the other user can be carried out with or without specification. Part or all of the product information can be provided to the user who has not purchased the product. By virtue of this, new marketing for market expansion can be carried out.

According to the present invention, part or all of the product information is transmitted to the other user terminal only by the predetermined number of transmission(s), and the predetermined number of transmission(s) is the number provided depending on the predetermined information about the product purchase(s). Therefore, for example, the user who has purchased the product(s) a plurality of times can utilize the product(s) he/she is not using. Moreover, the user can be prompted to further purchase the product. According to the present invention, since a limit about reproduction is provided on the content information transmitted from the user terminal to the other user terminal, the right of the artist or the content holder can be protected.

Moreover, according to the present invention, when the predetermined first condition is satisfied, registration is made to provide the first benefit to the user and/or, when the predetermined first condition is satisfied, the first benefit to be provided to the user is determined. Therefore, the user can be prompted to transmit part or all of the product information corresponding to the product, which has been purchased by the user, to the other user terminal. Moreover, according to the present invention, when the predetermined second condition is satisfied, registration is made to provide the second benefit to the other user and/or, when the predetermined second condition is satisfied, the second benefit to be provided to other the user is determined. Therefore, the other user can be prompted to transmit part or all of the product information to the other user terminal.

Moreover, according to the present invention, the predetermined first condition and/or the predetermined second condition is: the fact that part or all of the product information has been transmitted to the other user terminal, the fact that part or all of the received product information has been used by the other user terminal, the fact that input of the information about the benefit to be provided to the user has been received by operation input on the other user terminal, and/or the fact that the number of transmissions of part or all of the product information to the other user terminal is equal to or less than the predetermined number. Therefore, the other user who does not use the system or does not use the system often can be prompted to use the system, and energization of the system can be expected.

Moreover, according to the present invention, the content information and the information about the admission ticket of the event related to the content information and/or the product including the information about the benefit ticket used at the event can be sold on the Internet. According to the present invention, the administrator or the like can flexibly distribute the product benefit information, which is in various modes, to the user. Moreover, according to the present invention, the product having various variations can be provided to the user. Therefore, the satisfaction and buying interest of the user can be enhanced. Moreover, according to the present invention, a planned number of admission tickets of the event can be easily distributed. Moreover, according to the present invention, since predetermined timing is set to distribute the digital benefit, a time-limited campaign can be carried out.

Moreover, according to the present invention, a conventional problem of a large-quantity CD purchase and large-quantity CD disposal is eliminated, and the system without load on environments can be provided. According to the present invention, since the admission ticket and/or the benefit ticket of the event is managed by the user ID, which is linked to the user terminal 1, unlawful transfer of the admission ticket and/or the benefit ticket to the other user terminal can be prevented. Therefore, reselling of the admission ticket and/or the benefit ticket can be prevented. Moreover, according to the present invention, since the product can be distributed online, the necessity of controlling the inventory and logistics of actual products is eliminated.

### REFERENCE SIGNS LIST

1: user terminal, 2: server apparatus, 3: administrator terminal, 4: communication network, 11: control unit, 12: main memory, 13: storage, 14: input device, 15: display device, 16: communication interface, 21: control unit, 22: main memory, 23: storage, 23: communication interface, 30: artist name, 31: image, 32: title, 35: gallery icon, 36: player icon, 41: sound source download icon, 42: digital benefit download icon, 43: benefit ticket icon, 44: admission ticket icon, 45: gift icon, 51: remaining digital benefit counts, 52: the numbers of product purchases, 53: remaining benefit ticket counts, 54: giftable counts, 55: titles, 56: images, 57, 58: icon, 61: digital-package/gift acquiring icon, 62: my page icon, 63: artist/digital-package search icon, 64: store icon, 65: owned-admission-ticket list icon, 66: owned-benefit-ticket list icon, 71: benefit ticket information, 81: admission ticket information, 72, 82: checkboxes, 73, 83: icon.

1. A system including at least one computer apparatus, the system comprising:
a sending information generator that generates, by operation on a user terminal, sending information including readable information on another user terminal operated by another user; and
a transmitter that transmits part or all of a product information corresponding to a product purchased by a user to the other user terminal when the readable information including the sending information is read by the other user terminal.

2. The system according to claim 1, wherein
the transmitter transmits part or all of the product information to the other user terminal only by a predetermined number of transmission, and
the predetermined number of transmission is a number provided depending on predetermined information about product purchase.

3. The system according to claim 1, wherein
part or all of the product information transmitted to the other user terminal can be used by the other user terminal with a limit of a predetermined period or a predetermined number.

4. The system according to claim 1, comprising
a first benefit provider that makes registration to provide a first benefit to the user when a predetermined first condition is satisfied and/or determines the first benefit provided to the user when the predetermined first condition is satisfied.

5. The system according to claim 1, comprising
a second benefit provider that makes registration to provide a second benefit to the other user when a predetermined second condition is satisfied and/or determines the second benefit provided to the other user when the predetermined second condition is satisfied.

6. The system according to claim 4, wherein
the predetermined first condition is: a fact that part or all of the product information has been transmitted to the other user terminal, a fact that part or all of the received product information has been used by the other user terminal, a fact that information about a benefit to be provided to the user has been input by operation input on the other user terminal, and/or a fact that a number of transmission of part or all of the product information to the other user terminal is equal to or less than a predetermined number.

7. The system according to claim 4, wherein
the first benefit allows the user and/or the other user to make a purchase before predetermined sales date regarding a purchase of a predetermined product, to purchase the predetermined product, to purchase the predetermined product by increasing an upper limit on a purchasable number of the predetermined product, and/or to execute, regarding a predetermined lottery, the lottery at a lottery probability increased by a predetermined rate.

8. The system according to claim 4, comprising
a number storage that stores, in association with single sending information, a number of an allowed transmission of part or all of the product information to the other user terminal, wherein
the first benefit increases an upper limit of the number of the allowed transmission.

9. A method executed in a system including at least one computer apparatus, the method comprising:
generating, by operation on a user terminal, sending information including readable information on another user terminal operated by another user; and
transmitting part or all of a product information corresponding to a product purchased by a user to the other user terminal when the readable information including the sending information is read by the other user terminal.

10-13. (canceled)

14. The system according to claim 5, wherein
the predetermined second condition is: a fact that part or all of the product information has been transmitted to the other user terminal, a fact that part or all of the received product information has been used by the other user terminal, a fact that information about a benefit to be provided to the user has been input by operation input on the other user terminal, and/or a fact that a number of transmission of part or all of the product information to the other user terminal is equal to or less than a predetermined number.

15. The system according to claim 5, wherein
the second benefit allows the user and/or the other user to make a purchase before predetermined sales date regarding a purchase of a predetermined product, to purchase the predetermined product, to purchase the predetermined product by increasing an upper limit on a purchasable number of the predetermined product, and/or to execute, regarding a predetermined lottery, the lottery at a lottery probability increased by a predetermined rate.

16. The system according to claim 5, comprising
a number storage that stores, in association with single sending information, a number of an allowed transmission of part or all of the product information to the other user terminal, wherein
the second benefit increases an upper limit of the number of the allowed transmission.
